(19) United States
(12) Patent Application Publication
(10) Pub. No.: US 2026/0199922 A1
(43) Pub. Date: Jul. 16, 2026

(54) OBSTRUCTION DETECTION IN FLUID DISPENSING APPARATUS

(71) Applicant: Aeroseal LLC, Miamisburg, OH (US)

(72) Inventors: Sachin Kumar Koyeti, Dayton, OH (US); Ethan James Shephard, Dayton, OH (US); Akshai Addaguduru, West Carrollton, OH (US); Suraj Kant Sahu, Moraine, OH (US)

(21) Appl. No.: 19/021,418

(22) Filed: Jan. 15, 2025

(51) Int. Cl. B05B 15/50

(52) U.S. Cl. CPC B05B 15/50

(57) ABSTRACT

A fluid dispensing apparatus is disclosed. The apparatus receives first pressure value associated with dispensing aperture at first time period. The first pressure value is indicative of first volume of fluid dispensed through dispensing aperture. The apparatus receives second pressure value associated with dispensing aperture at second time period. The second pressure value is indicative of second volume of fluid dispensed through dispensing aperture. The apparatus determines change value associated with flow of fluid through dispensing aperture based on first pressure value and second pressure value. The apparatus determines operational state of pressure delivery unit based on change value. The apparatus identifies obstruction in dispensing aperture based on change value to correspond to predefined threshold. The predefined threshold is based on operational state of pressure delivery unit. The apparatus generates obstruction data based on identified obstruction and device data associated with fluid dispensing apparatus and output obstruction data.

### TECHNICAL FIELD

The disclosure relates to fluid dispensing apparatus, and more specifically, a fluid dispensing apparatus and a method for obstruction detection in fluid dispensing apparatus.

### BACKGROUND

A fluid dispensing apparatus is a specially designed device to regulate a flow of a fluid substance through a dispensing aperture in a controlled manner. Typically, the fluid dispensing apparatus includes a storage tank that stores the fluid and a dispensing mechanism that controls the flow of the fluid. For example, the dispensing mechanism may include such as but is not limited to a valve, a pump, or a nozzle through which the fluid is dispensed. Further, the fluid dispensing apparatus may include a delivery mechanism to direct the fluid to a desired location.

Such a fluid dispensing apparatus may be utilized in various industrial dispensing systems for example, for dispensing different adhesives, lubricants, sealants, or other solutions in precise and controlled amounts. Though such a fluid dispensing apparatus is designed to control the flow, however, they often encounter challenges such as nozzle clogging, leakage, and inconsistent flow. For example, residues, particulates, or contaminants within the fluid can accumulate within the dispensing aperture, thereby leading to a buildup of fluid residue therein. This may lead to blockage in the dispensing aperture that will impair fluid flow, thereby affecting the performance of the fluid dispensing apparatus. For example, such a buildup of fluid residue within the dispensing aperture can lead to exacerbate wear and tear on the dispensing aperture, thereby contributing to operational issues.

Traditionally, detecting clogging in the dispensing aperture often requires human involvement, such as visual checks of the nozzle and measuring a flow rate of the fluid through the nozzle. Further, some of the existing techniques to detect clogging may be invasive. However, such techniques may overlook partial clogs that may not fully block the flow, thereby affecting the working of the fluid dispensing apparatus. Therefore, there is a need to overcome limitations associated with accurate and efficient clogging detection in the fluid dispensing apparatus.

### SUMMARY

The present disclosure provides a fluid dispensing apparatus, a method, and a computer programmable for obstruction detection in fluid dispensing apparatus.

In one aspect, a fluid dispensing apparatus is disclosed. The fluid dispensing apparatus includes a storage unit to store a fluid, a dispensing aperture to dispense the fluid, a pressure delivery unit to supply pressure to cause a flow of the fluid from the storage unit to the dispensing aperture, and one or more processors configured to execute computer-executable instructions to receive a first pressure value associated with the dispensing aperture at a first time period. The first pressure value is indicative of a first volume of the fluid dispensed through the dispensing aperture. The one or more processors are further configured to receive a second pressure value associated with the dispensing aperture at a second time period. The second pressure value is indicative of a second volume of the fluid dispensed through the dispensing aperture. The second time period is subsequent to the first time period. The one or more processors are further configured to determine a change value associated with the flow of the fluid through the dispensing aperture based on the first pressure value and the second pressure value fluid dispensing apparatus. The one or more processors are further configured to determine an operational state of the pressure delivery unit based on the change value. The operational state corresponds to one of a first state or a second state fluid dispensing apparatus. The one or more processors are further configured to identify an obstruction in the dispensing aperture based on the change value to correspond to a predefined threshold. The predefined threshold is based on the operational state of the pressure delivery unit. The one or more processors are further configured to generate obstruction data based on the identified obstruction and device data associated with the fluid dispensing apparatus, and output the obstruction data.

In an embodiment, the first state corresponds to an active state of the pressure delivery unit, and the one or more processors are further configured to determine the change value greater than the predefined threshold associated with the active state of the pressure delivery unit. The one or more processors are further configured to identify the obstruction in the dispensing aperture based on the determination.

In an embodiment, the second state corresponds to an inactive state of the pressure delivery unit, and the one or more processors are further configured to determine change value less than the predefined threshold associated with the inactive state of the pressure delivery unit. The one or more processors are further configured to identify the obstruction in the dispensing aperture based on the determination.

In an embodiment, the one or more processors are further configured to generate a notification associated with the obstruction in the dispensing aperture based on the obstruction data.

In an embodiment, the one or more processors are further configured to generate an alert indicative of the obstruction in the dispensing aperture based on the obstruction data. The one or more processors are further configured to output the alert.

In an embodiment, the alert corresponds to at least one of a visual alert, an auditory alert, or a digital alert.

In an embodiment, the fluid dispensing apparatus further includes one or more sensors. The one or more processors are further configured to receive, using the one or more sensors, the first pressure value associated with the dispensing aperture and the second pressure value associated with the dispensing aperture fluid dispensing apparatus.

In an embodiment, the one or more sensors include a hydraulic pressure sensor.

In an embodiment, the fluid includes at least a portion of an aerosolized sealant.

In another aspect, a method for obstruction detection in fluid dispensing apparatus is disclosed. The method includes receiving a first pressure value associated with a dispensing aperture at a first time period. The first pressure value is indicative of a first volume of a fluid dispensed through the dispensing aperture fluid dispensing apparatus. The method further includes receiving a second pressure value associated with the dispensing aperture at a second time period. The second pressure value is indicative of a second volume of the fluid dispensed through the dispensing aperture. The second time period is subsequent to the first time period fluid dispensing apparatus. The method further includes determining a change value associated with a flow of the fluid through the dispensing aperture based on the first pressure value and the second pressure value. The method further includes determining an operational state of a pressure delivery unit based on the change value. The operational state corresponds to one of a first state, or a second state. The method further includes identifying an obstruction in the dispensing aperture based on the change value to correspond to a predefined threshold. The predefined threshold is based on the operational state of the pressure delivery unit. The method further includes generating obstruction data based on the identified obstruction and device data associated with the fluid dispensing apparatus and outputting the obstruction data.

In an embodiment, the first state corresponds to an active state of the pressure delivery unit, and the method includes determining the change value greater than the predefined threshold associated with the active state of the pressure delivery unit. The method includes identifying the obstruction in the dispensing aperture based on the determination.

In an embodiment, the second state corresponds to an inactive state of the pressure delivery unit, and the method further includes determining a change value less than the predefined threshold associated with the inactive state of the pressure delivery unit. The method further includes identifying the obstruction in the dispensing aperture based on the determination.

In an embodiment, the method further includes generating a notification associated with the obstruction in the dispensing aperture based on the obstruction data.

In an embodiment, the method further includes generating an alert indicative of the obstruction in the dispensing aperture based on the obstruction data. The method further includes outputting the alert.

In an embodiment, the alert corresponds to at least one of a visual alert, an auditory alert, or a digital alert.

In an embodiment, the method further includes receiving, using one or more sensors, the first pressure value associated with the dispensing aperture and the second pressure value associated with the dispensing aperture.

In an embodiment, the one or more sensors include a hydraulic pressure sensor.

In an embodiment, the fluid includes at least a portion of an aerosolized sealant.

In yet another aspect, a computer programmable product including a non-transitory computer-readable storage medium having thereon computer-executable instructions for controlling an operation of a testing device for performing an air leakage test, which when executed by one or more processors, cause the one or more processors to carry out operations including receiving a first pressure value associated with a dispensing aperture at a first time period. The first pressure value is indicative of a first volume of a fluid dispensed through the dispensing aperture. The operations further include receiving a second pressure value associated with the dispensing aperture at a second time period. The second pressure value is indicative of a second volume of the fluid dispensed through the dispensing aperture. The second time period is subsequent to the first time period. The operations further include determining a change value associated with a flow of the fluid through the dispensing aperture based on the first pressure value and the second pressure value. The operations further include determining an operational state of a pressure delivery unit based on the change value. The operational state corresponds to one of a first state, or a second state. The operations further include identifying an obstruction in the dispensing aperture based on the change value to correspond to a predefined threshold. The predefined threshold is based on the operational state of the pressure delivery unit. The operations further include generating obstruction data based on the identified obstruction and device data associated with the fluid dispensing apparatus and outputting the obstruction data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 illustrates a block diagram of a network environment in which a fluid dispensing apparatus is implemented, in accordance with an embodiment of the disclosure;

FIG. 2 illustrates a block diagram of the apparatus of FIG. 1, in accordance with an embodiment of the disclosure;

FIG. 3A and FIG. 3B collectively illustrate an exemplary flowchart for obstruction detection in the fluid dispensing apparatus, in accordance with an embodiment of the disclosure;

FIG. 4 illustrates an exemplary diagram of the fluid dispensing apparatus, in accordance with an embodiment of the disclosure;

FIG. 5A, FIG. 5B and FIG. 5C illustrate exemplary diagrams of the dispensing aperture associated with the fluid dispensing apparatus, in accordance with an embodiment of the disclosure;

FIG. 6A, FIG. 6B, FIG. 6C and FIG. 6D illustrate exemplary diagrams of the dispensing aperture associated with the fluid dispensing apparatus, in accordance with an embodiment of the disclosure; and

FIG. 7 illustrates an exemplary flowchart of a method for obstruction detection in the fluid dispensing apparatus, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatus and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

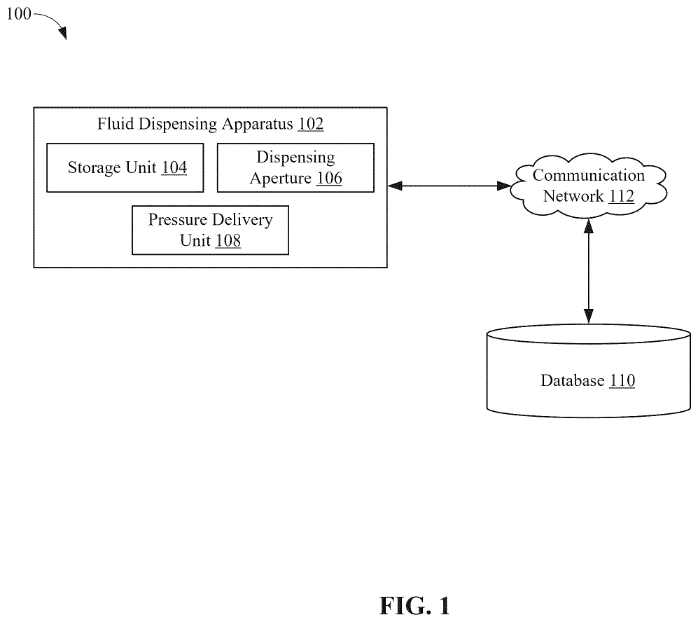

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 7, a brief description concerning the various components of the present disclosure will now be briefly discussed. Reference will be made to the figures showing various embodiments of a fluid dispensing apparatus, and a method for obstruction detection in the fluid dispensing apparatus.

FIG. 1 illustrates a block diagram of a network environment 100 in which a fluid dispensing apparatus 102 is implemented, in accordance with one or more embodiments of the present disclosure. The network environment 100 includes the fluid dispensing apparatus 102.

The fluid dispensing apparatus 102 hereinafter referred to as apparatus 102. The apparatus 102 is configured to perform the operation of detecting obstruction in the dispensing aperture 106. The apparatus 102 may employ one or more pressure values associated with the dispensing aperture 106 to identify the obstruction. The apparatus 102 may be employed in various industrial applications to regulate the flow of fluid. For example, in the automative industry, the apparatus 102 may facilitate dispensing adhesives, lubricants, or sealants in an assembly line. In another example, the apparatus 102 may be employed to dispense precise volumes of gels or reagents for medical purposes. Further, the apparatus 102 may dispense liquid ingredients in food production and packaging, or chemical industries.

In an embodiment, the apparatus 102 may include a storage unit 104, a dispensing aperture 106, and a pressure delivery unit 108. The storage unit 104 may be configured to store the fluid to be dispensed. For example, the storage unit 104 includes but is not limited to a reservoir, a container, or a storage tank that holds the fluid. The dispensing aperture 106 may be configured to dispense the fluid. For example, the dispensing aperture 106 may correspond to a nozzle or a dispensing tip through which the fluid exits the apparatus 102. Further, the pressure delivery unit 108 may be configured to supply pressure to cause a flow of the fluid from the storage unit 104 to the dispensing aperture 106. For example, the pressure delivery unit 108 may generate force to transmit the fluid from the storage unit 104 to the dispensing aperture 106. An example of the pressure delivery unit 108 may include but is not limited to a mechanical pump. In an example, the pressure delivery unit 108 may use air in pneumatic systems.

The network environment 100 further includes a database 110 and a communication network 112. The database 110 is an organized collection of structured information, or data, typically stored electronically in a computer apparatus. The database 110 is configured to receive, store, and transmit data that may be collected from various sensors. The database 108 may store the one or more pressure values associated with the dispensing aperture 106. The one or more pressure values may be associated with a volume of fluid passing through the dispensing aperture 106 at a given timestamp.

The communication network 112 may be wired, wireless, or any combination of wired and wireless communication networks, such as cellular, Wi-Fi, internet, local area networks, or the like. In some embodiments, the communication network 112 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global apparatus for mobile communications (GSM), Internet protocol multimedia system (IMS), universal mobile telecommunications apparatus (UMTS), etc., as well as any other suitable wireless medium, e.g., worldwide interoperability for microwave access (WiMAX), Long Term Evolution (LTE) networks (e.g. LTE-Advanced Pro), 5G New Radio networks, International Telecommunication Union-International Mobile Telecommunications (ITU-IMT) 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In operation, the apparatus 102 may be configured to receive a first pressure value associated with the dispensing aperture 106 at a first time period. The first pressure value may be indicative of a first volume of the fluid dispensed through the dispensing aperture 106. The apparatus 102 may be further configured to receive a second pressure value associated with the dispensing aperture 106 at a second time period. The second pressure value is indicative of a second volume of the fluid dispensed through the dispensing aperture 106. Further, the second time period is subsequent to the first time period. For example, the apparatus 102 receives the first pressure value (P1) at the first time period (T1) and the second pressure value (P2) at the second time period (T2). In such an example, the first time period (T1) precedes the second time period (T2).

In an example, the apparatus 102 may be configured to receive the first pressure value and the second pressure value using pressure sensors. The pressure sensor(s) may be devices used to measure the pressure of gases or liquids and convert this information into an electrical signal. In an embodiment, the pressure sensor(s) may be spread across the dispensing aperture 106 to provide a suitable environment for measuring the accurate pressure. Examples of the pressure sensor(s) may include, but are not limited to, Aneroid, Barometer Pressure, Sensor Manometer, Pressure Sensor, Bourdon Tube Pressure Sensor, Vacuum (Pirani) Pressure Sensor, Sealed Pressure Sensor, Piezoelectric Pressure Sensors. The pressure sensor(s) may be configured to generate the pressure data associated with the dispensing aperture 106.

Thereafter, the apparatus 102 determines a change value associated with the flow of the fluid through the dispensing aperture 106 based on the first pressure value (P1) and the second pressure value (P2). For example, the change value may correspond to a rate of change of the one or more pressure values such as the first pressure value (P1) and the second pressure value (P2), over a period of time, such as the first time period (T1) and the second time period (T2). In an embodiment, a rate of change of the one or more pressure values may correspond to a pressure build up rate, when the second pressure value (P2) is greater than the first pressure value (P1) over the time period. Alternatively, a rate of change of the one or more pressure values may correspond to a pressure decay rate, when the second pressure value (P2) is less than the first pressure value (P1) over the time period.

Further, the apparatus 102 may determine an operational state of the pressure delivery unit 108 based on the change value. The operational state corresponds to one of: a first state, or a second state. For example, when the change value corresponds to the pressure build up rate, the apparatus 102 may determine the operational state of the pressure delivery unit 108 as the first state. Alternatively, when the change value corresponds to the pressure decay rate, the apparatus 102 may determine the operational state of the pressure delivery unit 108 as the second state. In an example, the first state corresponds to an active state of the pressure delivery unit 108, or an ON state of the pressure delivery unit 108. In another example, the second state corresponds to an inactive state of the pressure delivery unit 108, or an OFF state of the pressure delivery unit 108.

Upon determination of the operational state, the apparatus 102 may identify an obstruction in the dispensing aperture 106 based on the change value to correspond to a predefined threshold. The predefined threshold is based on the operational state of the pressure delivery unit 108. For example, for the first state of the pressure delivery unit 108, the predefined threshold may correspond to a pressure value (X1), and for the second state of the pressure delivery unit 108, the predefined threshold may correspond to a pressure value (X2).

For example, the apparatus 102 may be configured to compare the change value with a corresponding predefined threshold based on the operational state of the pressure delivery unit 108. Thereafter, the apparatus 102 may be configured to detect an obstruction in the dispensing aperture 106 based on the comparison. In an embodiment, the apparatus 102 may generate obstruction data based on the identified obstruction and device data associated with the fluid dispensing apparatus 102 and output the obstruction data. The obstruction data may be data associated with the clogging of the dispensing aperture 106. The device data may be the data associated with a pressure value associated with the volume of the fluid dispensed through the dispensing aperture 106 to maintain the performance of the apparatus 102. For example, the fluid may be stored in the storage unit 104. Further, the storage unit 104 may be a metal container. In an example, the storage unit 104 may be made from similar or dissimilar metallic materials such as galvanized steel, stainless steel, or aluminum, but is not limited thereto. In an embodiment, the apparatus 102 may dispense the stored fluid from the storage unit 104 to the dispensing aperture 106 using the pressure delivery unit 108.

In an embodiment, the fluid may include air or at least a portion of aerosolized sealant mixed with the air. The aerosol sealant may be supplied to the dispensing aperture 106 with the help of the apparatus 102 creating an air flow inside the pressure delivery unit 108 that may facilitate to supply pressure to cause a flow of the fluid. The small aerosol particles of the sealant will remain suspended in the air due to continuous air movement. The particles travel through the air enclosure system seeking holes and cracks that are located throughout the dispensing aperture 106. The adhesive enclosure sealing particles attach directly onto the edges of any hole and crack, effectively sealing it without coating the inside of the dispensing aperture 106. In an example, a residual sealant may remain attached around or within the dispensing aperture 106. Such a residual sealant may dry over the time period and build up a hardened layer, thereby obstructing a flow of the fluid through the dispensing aperture 106 that will impair the fluid flow. This may affect the performance of the fluid dispensing apparatus 102 and may lead to exacerbating wear and tear on the dispensing aperture 106, thereby contributing to operational issues. Such clogging may be treated by proper cleaning and regular visual checks. However, this may often require human involvement. Further, some of the existing techniques to detect clogging may be invasive and may overlook partial clogs that don't fully block the fluid flow.

To overcome such limitations, the proposed apparatus 102 may monitor pressure values of the fluid over the time period and detect the obstruction in the dispensing aperture 106 based on a change value associated with the flow of the fluid through the dispensing aperture 106. This may facilitate detecting any obstruction efficiently during the operation, thereby improving the fluid flow, and enhancing the overall functioning of the fluid dispensing apparatus 102.

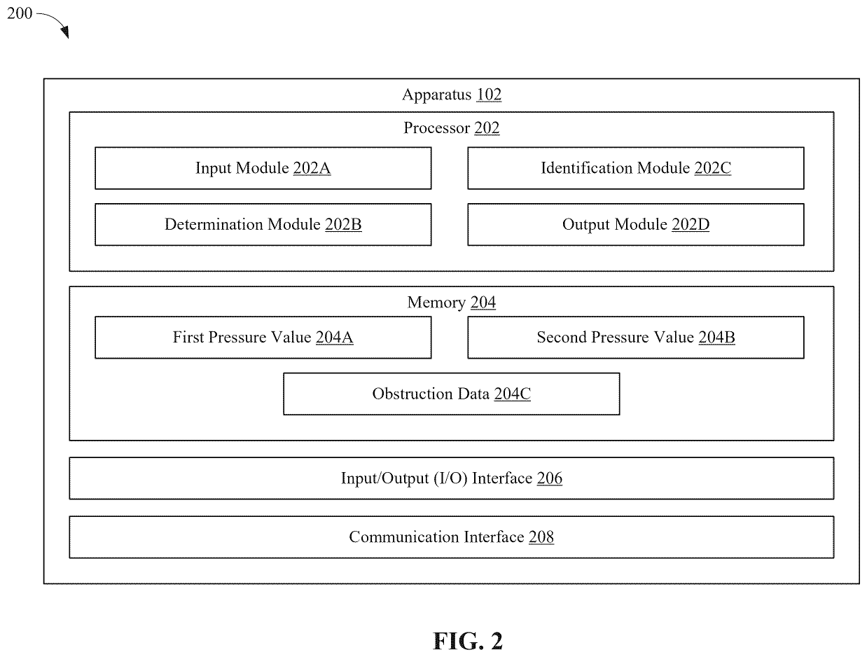

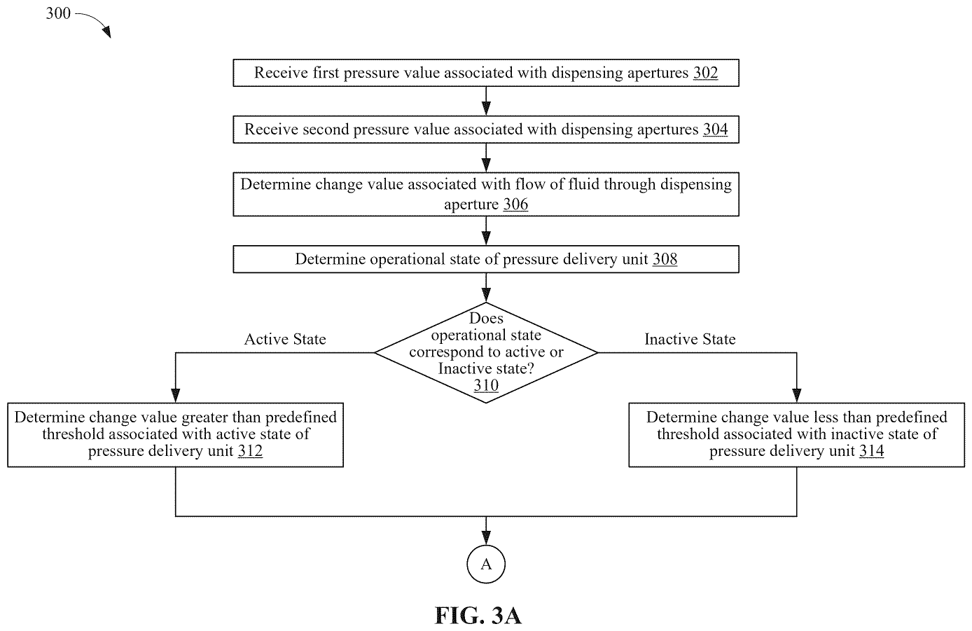

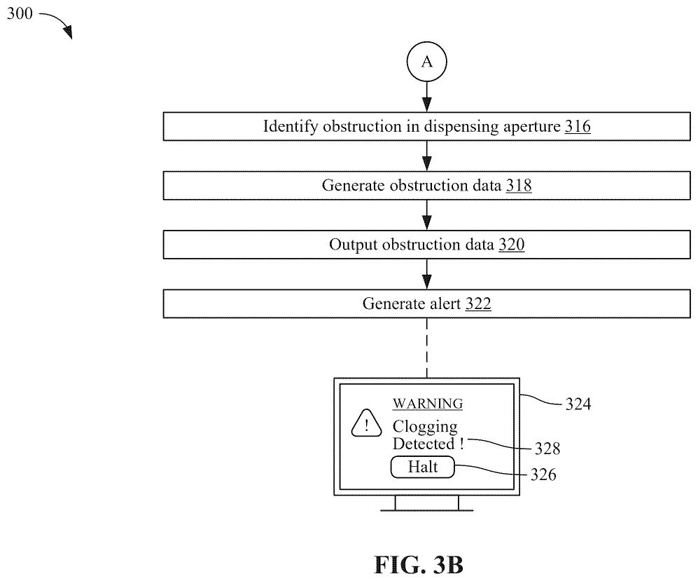

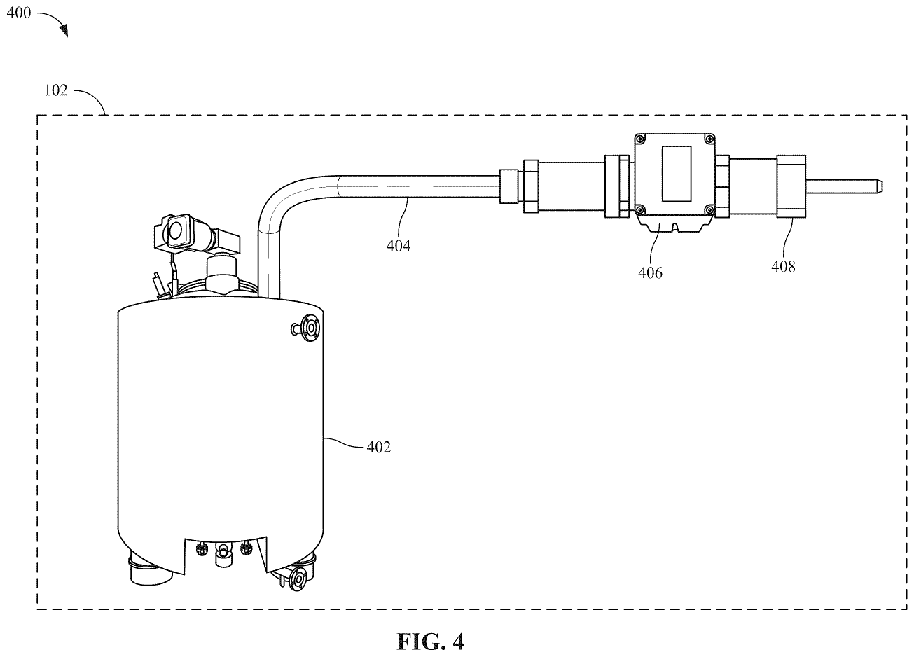

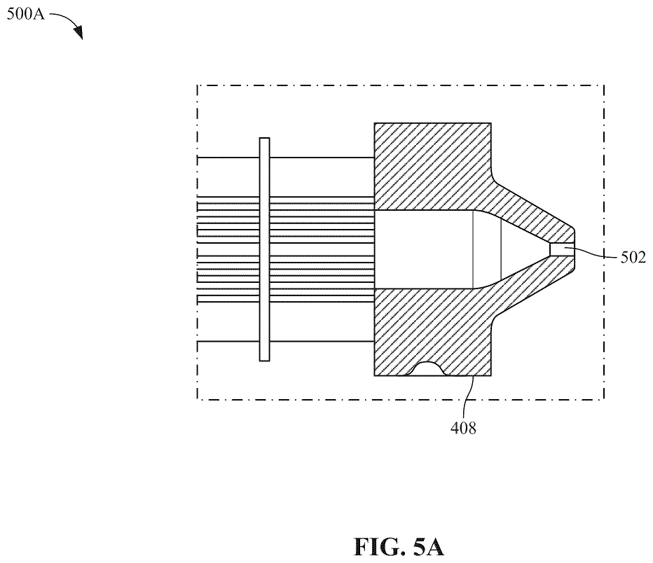

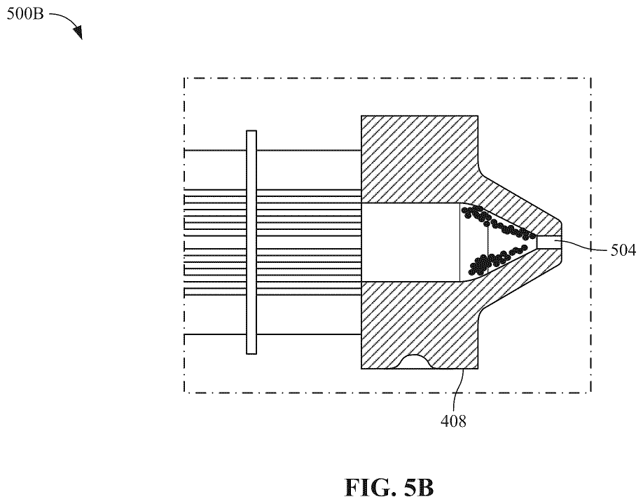

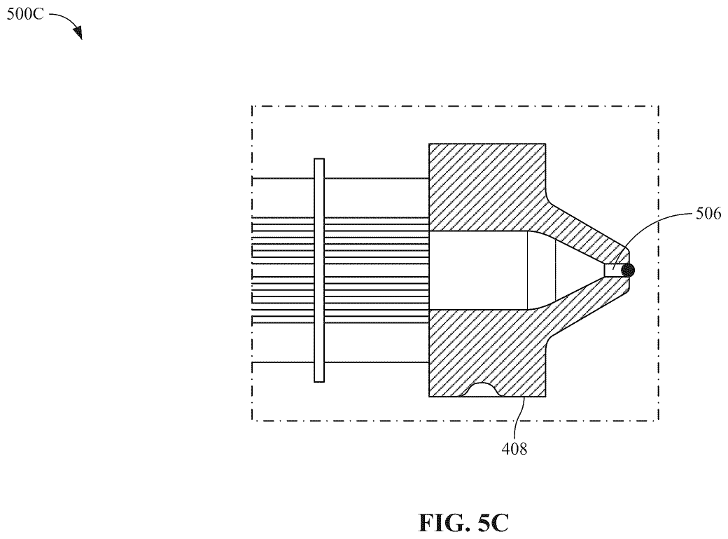

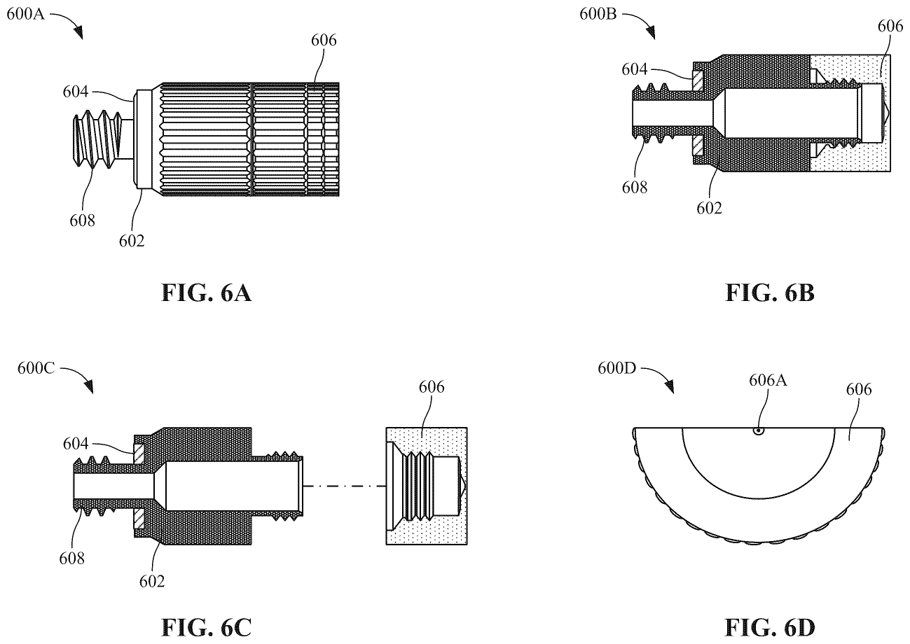

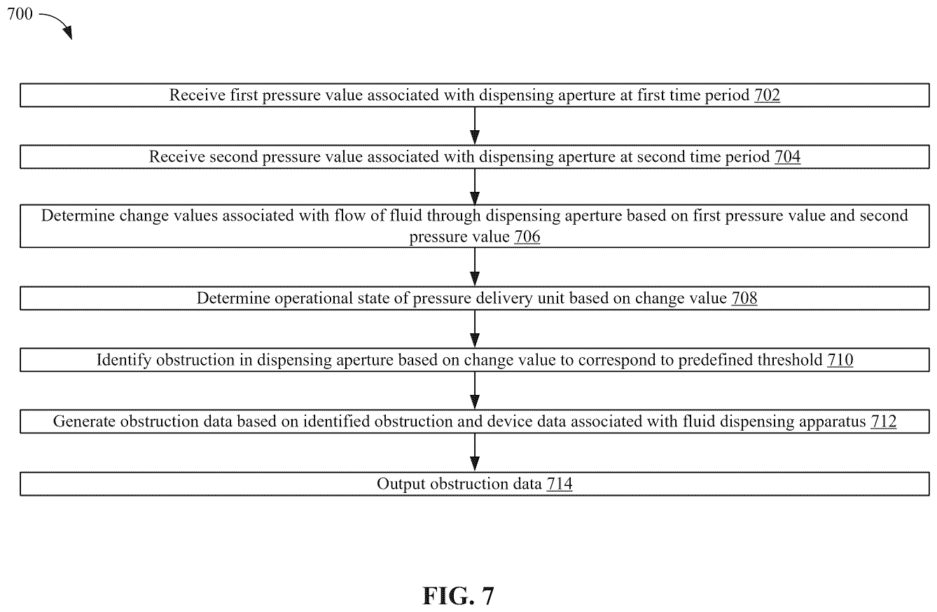

The functions or operations executed by the apparatus 102 are described in detail, for example, in conjunction with FIG. 2, FIG. 3A, FIG. 3B, FIG. 4, FIG. 5A, FIG. 5B, FIG. 5C, FIG. 6A, FIG. 6B, FIG. 6C, FIG. 6D and FIG. 7.

FIG. 2 illustrates a block diagram 200 of the apparatus 102, in accordance with an embodiment of the disclosure. The apparatus 102 may include at least one processor (referred to as a processor 202, hereinafter), at least one non-transitory memory (referred to as a memory 204, hereinafter), an input/output (I/O) interface 206, and a network interface 208. The processor 202 may include modules, depicted as, an input module 202A, a determination module 202B, an identification module 202C, and an output module 202D. Although the present illustration depicts the apparatus 102 to include the processor 202 however, this should not be construed as a limitation. In other examples, the apparatus 102 and the processor 202 may not be co-located and may operate independently or inter-dependently.

The processor 202 may be connected to the memory 204, the I/O interface 206, and the network interface 208 through one or more wired or wireless connections. Although in FIG. 2, it is shown that the apparatus 102 includes the processor 202, the memory 204, the I/O interface 206, and the network interface 208 however, the disclosure may not be so limiting and the apparatus 102 may include fewer or more components to perform the same or other functions of the apparatus 102.

In accordance with an embodiment, the apparatus 102 may store data generated by the modules of the processor 202 in the memory 204. The data generated by the modules may include, for example, a first pressure value 204A, and a second pressure value 204B, obstruction data 204C.

In accordance with an embodiment, the apparatus 102 may be configured to monitor and detect obstruction in the dispensing aperture 106 of the fluid dispensing apparatus 104. In an embodiment, the apparatus 102 may receive the first pressure value 204A and the second pressure value 204B associated with the fluid dispensing apparatus 102. The processor 202 may utilize the received first pressure value 204A and the second pressure value 204B to detect the obstruction in the dispensing aperture 106 of the fluid dispensing apparatus 102. For example, the apparatus 102 may include, but is not limited to, an electronic control unit (ECU), an electronic control module (ECM), a computing device, a mainframe machine, a server, a computer workstation, any and/or any other device.

The processor 202 of the apparatus 102 may be configured to perform the obstruction detection for the dispensing aperture 106 of the fluid dispensing apparatus 104. The processor 202 may be embodied as one or more of various hardware processing means such as a coprocessor, a microprocessor, a digital signal processor (DSP), a processing element with or without an accompanying DSP, or various other processing circuitry including integrated circuits such as, for example, an ASIC (application-specific integrated circuit), an FPGA (field programmable gate array), a microsystem unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the apparatus 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the network interface 208 of the apparatus 102. The network interface 208 may provide an interface for accessing various features and data stored in the apparatus 102.

In an example, the processor 202 may be configured to retrieve the first pressure value 204A and the second pressure value 204B. Moreover, the output module 202D may be configured to output the obstruction data 204C to generate a notification indicative of the obstruction of the dispensing aperture 106.

The input module 202A of the processor 202 may be configured to obtain the first pressure value 204A and the second pressure value 204B associated with the fluid dispensing apparatus 104 and the dispensing aperture 106. The first pressure value 204A may be associated with the dispensing aperture 106 of the fluid dispensing apparatus 104. The first pressure value 204A may be associated with the volume of fluid passing through the dispensing aperture 106 at the first timestamp. The second pressure value 204B may be associated with the dispensing aperture 106 of the fluid dispensing apparatus 104. The second pressure value 204B may be associated with the volume of fluid passing through the dispensing aperture 106 at the second timestamp. In an example, the first pressure value 204A may be a first user input data or predefined data stored in the database 108. In an exemplary embodiment, the input module 202A may also be configured to receive the first pressure value 204A from a pressure sensor.

The determination module 202B of the processor 202 may be configured to determine the change value associated with the flow of the fluid through the dispensing aperture based on the first pressure value 204A and the second pressure value 204B. In an embodiment, the determination module 202B of the processor 202 may be configured to determine a rate of change of pressure values based on the first pressure value 204A and the second pressure value 204B. In an example, the rate of change of pressure values may be indicative of a pressure increase through the dispensing aperture 106 of the fluid dispensing apparatus 104 over the time period. In another example, the rate of change of pressure values may be indicative of a pressure decrease through the dispensing aperture 106 of the fluid dispensing apparatus 104 over the time period.

In an embodiment, the determination module 202B of the processor 202 may be configured to determine an operation state of the pressure delivery unit 108 based on the change value. In an example, the determination module 202B may determine the operational state of the pressure delivery unit 108 as the first state based on the determination that the rate of change of pressure values is indicative of the pressure increase through the dispensing aperture 106. In an embodiment, the determination module 202B may determine the operational state of the pressure delivery unit 108 as the second state based on the determination that the rate of change of pressure values is indicative of the pressure decrease through the dispensing aperture 106.

The identification module 202C of the processor 202 may be configured to identify an obstruction in the dispensing aperture 106 based on the change value to correspond to a predefined threshold. In an embodiment, the identification module 202C may be configured to identify the obstruction based on a comparison of the determined change value associated with the flow of the fluid through the dispensing aperture 106, and a corresponding predefined threshold is based on the operational state of the pressure delivery unit 108.

The output module 202D of the processor 202 may be configured to render an alert. In an embodiment, the apparatus 102 may be configured to generate obstruction data based on the identified obstruction and device data associated with the fluid dispensing apparatus 102, output the obstruction data. For example, the apparatus 102 may generate a notification associated with the obstruction in the dispensing aperture 106 based on the obstruction data. Further, the apparatus 102 may be configured to render an alert indicative of the obstruction of the dispensing aperture 106 of the fluid dispensing apparatus 104. The rendered alert may be generated based on the detected obstruction in the dispensing aperture 106 of the fluid dispensing apparatus 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the apparatus 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 may be embodied as an Application Specific Integrated Circuit (ASIC), Field Programmable Gate Array (FPGA), or the like, the processor 202 may be specifically configured hardware for performing the operations described herein.

The memory 204 of the apparatus 102 may be configured to store the first pressure value 204A associated with the dispensing aperture 106 of the fluid dispensing apparatus 104. The first pressure value 204A may be associated with the volume of the fluid passing through the dispensing aperture 106 at the first timestamp. In an embodiment, the memory 204 of the apparatus 102 may be configured to store the second pressure data 204B associated with the dispensing aperture 106 of the fluid dispensing apparatus 104. The second pressure value 204B may be associated with the volume of the fluid passing through the dispensing aperture 106 at the second timestamp. In an embodiment, the first pressure value 204A and the second pressure value 204B may be utilized by the determination module 202B to determine the rate of change of pressure values. In an embodiment, the memory 204 of the apparatus 102 may be configured to store the obstruction data 204C. The obstruction data 204C may be generated based on the identified obstruction and the device data associated with the fluid dispensing apparatus 102.

In some example embodiments, the I/O interface 206 may communicate with the apparatus 102 and display the input and/or output of the apparatus 102. As such, the I/O interface 206 may include a display and, in some embodiments, may also include a keyboard, a mouse, a touch screen, touch areas, soft keys, or other input/output mechanisms. In one embodiment, the apparatus 102 may include a user interface circuitry configured to control at least some functions of one or more I/O interface elements such as a display and, in some embodiments, a plurality of speakers, a ringer, one or more microphones and/or the like. The processor 202 and/or the I/O interface 206 circuitry including the processor 202 may be configured to control one or more functions of one or more I/O interface 206 elements through computer program instructions (for example, software and/or firmware) stored on the memory 204 accessible to the processor 202.

The network interface 208 may include the input interface and output interface for supporting communications to and from the apparatus 102 or any other component with which the apparatus 102 may communicate. The network interface 208 may be any means such as a device or circuitry embodied in either hardware or a combination of hardware and software that may be configured to receive and/or transmit data to/from a communications device in communication with the apparatus 102. In this regard, the network interface 208 may include, for example, an antenna (or multiple antennae) and supporting hardware and/or software for enabling communications with a wireless communication network interface. Additionally, or alternatively, the network interface 208 may include the circuitry for interacting with the antenna(s) to cause transmission of signals via the antenna(s) or to handle receipt of signals received via the antenna(s). In some environments, the network interface 208 may alternatively or additionally support wired communication. As such, for example, the network interface 208 may include a communication modem and/or other hardware and/or software for supporting communication via cable, digital subscriber line (DSL), universal serial bus (USB), or other mechanisms.

The fluid dispensing apparatus 104 may be operable to supply the fluid to the dispensing aperture 106 for dispersing the fluid. For example, the fluid dispensing apparatus 104 may be a pressure pump. The fluid dispensing apparatus 104 may be connected to the dispensing aperture 106 to provide fluid through the dispensing aperture 106. The fluid dispensing apparatus 104 may allow the fluid to be forced through the dispensing aperture 106. For example, the fluid dispensing apparatus 104 may pressurize the fluid to a desired predefined target pressure value through the dispensing aperture 106. In an embodiment, the fluid dispensing apparatus 104 may be one of a peristaltic pump apparatus, a diaphragm pump apparatus, a gear pump apparatus, a centrifugal pump apparatus, a piston pump apparatus, a solenoid driven dispenser apparatus, a rotary vane pump apparatus, a syringe pump apparatus, a gravity feed dispenser apparatus, or an electromagnetic pump apparatus. Details about the fluid dispensing apparatus 104 are provided, for example, in FIG. 4.

FIG. 3A and FIG. 3B collectively illustrate an exemplary flowchart 300 for obstruction detection of the fluid dispensing apparatus 102, in accordance with an embodiment of the disclosure. FIG. 3 is explained in conjunction with elements from FIG. 1 and FIG. 2. The exemplary operations 300 for obstruction detection of the fluid dispensing apparatus 102 may start at 302 and may be performed by any computing system, such as by the apparatus 102 of FIG. 1 or the processor 202 of FIG. 2. Although illustrated with discrete blocks, the exemplary operations associated with one or more blocks of the schematic flow diagram 300 may be divided into additional blocks, combined into fewer blocks, or eliminated, depending on the particular implementation.

At 302, the first pressure value 204A associated with the dispensing aperture 106 may be received. In an embodiment, the apparatus 102 may receive the first pressure value 204A associated with the dispensing aperture 106 at a first time period. The first pressure value 204A may be indicative of a first volume of the fluid dispensed through the dispensing aperture 106. For example, the apparatus 102 may be configured to receive the first pressure value 204A using one or more sensors spread across the dispensing aperture 106 to provide a suitable environment for measuring the accurate first pressure value 204A. For example, the one or more sensors may correspond to a pressure sensor. The pressure sensor may be a device used to measure the pressure of gases or liquids and convert this information into an electrical signal. Further, the pressure sensor may be configured to generate the pressure data associated with the dispensing aperture 106. Examples of the pressure sensor may include but are not limited to a hydraulic pressure sensor, aneroid barometer pressure sensor, manometer pressure sensor, bourdon tube pressure sensor, vacuum (Pirani) pressure sensor, sealed pressure sensor, and piezoelectric pressure sensor.

At 304, the second pressure value 204B associated with the dispensing aperture 106 may be received. In an embodiment, the apparatus 102 may receive the second pressure value 204B associated with the dispensing aperture 106 at a second time period. The second pressure value 204B may be indicative of a second volume of the fluid dispensed through the dispensing aperture 106. For example, the apparatus 102 may be configured to receive the second pressure value 204B using the one or more sensors spread across the dispensing aperture 106 to provide a suitable environment for measuring the accurate second pressure value 204B. For example, the one or more sensors may correspond to a pressure sensor, such as the hydraulic pressure sensor.

In an embodiment, the second time period is subsequent to the first time period. For example, the apparatus 102 may be configured to receive the first pressure value 204 such as 1500 pounds per square inch (PSI) at the first time period, such as 00:08:00 Hrs. and the apparatus 102 may be configured to receive the second pressure value 204B such as 1550 PSI at the second time period, such as 00:08:01 Hrs.

At 306, a change value associated with the flow of the fluid through the dispensing aperture 106 may be determined. In an embodiment, the apparatus 102 may be configured to determine the change value associated with the flow of the fluid through the dispensing aperture 106 based on the first pressure value 204A and the second pressure value 204B. For example, the first pressure value 204A may be 1500 PSI at the first time period, such as 00:08:00 hrs, and the second pressure value 204B may be 1550 PSI at the second time period, such as 00:08:01 Hrs. The apparatus 102 may determine the change value associated with the flow of fluid as 50 PSI per second. This may be indicative of a pressure increase through the dispensing aperture 106 over the time period. Such a change value indicative of the increase in the pressure value through the dispensing aperture 106 over the time period may correspond to a pressure buildup rate.

For example, the first pressure value 204A may be 1600 PSI at the first time period, such as 00:09:25 hrs, and the second pressure value 204B may be 1500 PSI at the second time period, such as 00:09:26 Hrs. The apparatus 102 may determine the change value associated with the flow of fluid as 100 PSI per second. This may be indicative of a pressure decrease through the dispensing aperture 106 over the time period. Such a change value indicative of a decrease in the pressure value through the dispensing aperture 106 over the time period may correspond to a pressure decay rate.

In an embodiment, the apparatus 102 may determine a change in the pressure value within an accumulator, based on a difference between the first pressure value (P1) and the second pressure value (P2). The determined change in the pressure value may indicate a change in the flow of the fluid through the dispensing aperture 106. The accumulator in the fluid dispensing apparatus refers to a device used to store the fluid, for example, the storage unit 104. Further, the accumulator may be configured to regulate the flow of the fluid to compensate for pressure fluctuations in the fluid dispensing apparatus 102, thereby maintaining consistent fluid pressure at the dispensing aperture 106. For example, the flow of the fluid is determined using the following equation:

$$q = Δ p / kt ,$$

here q denotes a flow rate of the fluid from the storage unit 104 to the dispensing aperture 106, Δp denotes a pressure difference between the first pressure value and the second pressure value, k denotes an accumulator constant, and t denotes a duration for which the fluid flows through the dispensing aperture 106.

In an example, the accumulator may correspond for example, but is not limited to, piston, bladder, or diaphragm. Further, the accumulator constant relates to a change in volume of the fluid stored within the accumulator. The accumulator constant indicates an amount of the fluid the accumulator may deliver or absorb for the change in the pressure value.

At 308, an operational state of the pressure delivery unit 108 may be determined. In an embodiment, the apparatus 102 may be configured to determine the operational state of the pressure delivery unit 108 based on the change value. The operational state of the pressure delivery unit 108 may be indicative of the working state of the pressure delivery unit 108. The operational state may correspond to one of a first state or a second state. For example, when the change value may correspond to the pressure buildup rate, the apparatus 102 may determine the operational state of the pressure delivery unit 108 as the first state. The first state may correspond to an active state of the pressure delivery unit 108. The active state of the pressure delivery unit 108 may correspond to an ON state of the pressure delivery unit 108, when the flow of the fluid may be initiated from the storage unit 104 to the dispensing aperture 106.

In another example, when the change value may correspond to the pressure decay rate, the apparatus 102 may determine the operational state of the pressure delivery unit 108 as the second state. The second state may correspond to an inactive state of the pressure delivery unit 108. The inactive state of the pressure delivery unit 108 may correspond to an OFF state of the pressure delivery unit 108, when the flow of the fluid may be terminated from the storage unit 104 to the dispensing aperture 106.

At 310, whether the operational state corresponds to an active or an inactive state may be determined. In an embodiment, when the first state corresponds to the active state of the pressure delivery unit 108, the control may pass to 312, otherwise, when the second state corresponds to the inactive state of the pressure delivery unit 108, the control may pass to 314.

At 312, the change value greater than a predefined threshold may be determined. In an embodiment, the apparatus 102 may be configured to determine the change value greater than the predefined threshold associated with the active state of the pressure delivery unit 108. The predefined threshold may be indicative of the pressure value associated with the dispensing aperture 106 to maintain the performance of the apparatus 102 during the active state. For example, during the active state, if the change value is greater than the predefined threshold, this may indicate an obstruction in the dispensing aperture 106.

At 314, the change value less than a predefined threshold may be determined. In an embodiment, the apparatus 102 may be configured to determine the change value less than the predefined threshold associated with the inactive state of the pressure delivery unit 108. The predefined threshold may be indicative of the pressure value associated with the dispensing aperture 106 to maintain the performance of the apparatus 102 during the inactive state. For example, during the inactive state, if the change value is less than the predefined threshold, this may indicate an obstruction in the dispensing aperture 106.

At 316, the obstruction in the dispensing aperture 106 may be identified. In an embodiment, the apparatus 102 may be configured to identify the obstruction in the dispensing aperture 106 based on the change value to correspond to the predefined threshold. The predefined threshold is based on the operational state of the pressure delivery unit 108. For example, the predefined threshold associated with the inactive state may be, but not limited to, 300 PSI/s, and the predefined threshold associated with the active state may be, but not limited to, 450 PSI/s.

In an embodiment, the apparatus 102 may be configured to compare the change value with the predefined threshold associated with the operational state of the pressure delivery unit 108. Further, the apparatus 102 may be configured to identify the obstruction in the dispensing aperture 106 based on the comparison. For example, for the active state of the pressure delivery unit 108, if the change value is greater than the predefined threshold associated with the active state, the apparatus 102 may identify the obstruction. In another example, for the inactive state of the pressure delivery unit 108, if the change value is less than the predefined threshold associated with the inactive state, the apparatus 102 may identify the obstruction.

At 318, the obstruction data 204C may be generated. In an embodiment, the apparatus 102 may be configured to generate the obstruction data 204C based on the identified obstruction and device data associated with the fluid dispensing apparatus 102. The obstruction data 204C may be data associated with obstruction (such as blockage or clogging) of the dispensing aperture 106. For example, the obstruction data 204C may include data associated with a severity of obstruction in the dispensing aperture 106 and its impact on the flow of the fluid and performance of the apparatus 102. In an embodiment, the device data may be the data associated with a pressure value associated with the volume of the fluid dispensed through the dispensing aperture 106 to maintain the performance of the apparatus 102. For example, the device data may include the predefined threshold corresponding to the operational state of the pressure delivery unit 108.

At 320, the obstruction data 204C may be output. In an embodiment, the apparatus 102 may be configured to output the obstruction data 204C. In an embodiment, the apparatus 102 may be configured to generate a notification associated with the obstruction in the dispensing aperture 106 based on the obstruction data 204C. For example, the apparatus 102 may be configured to output the notification or warning indicative of the clogging in the dispensing aperture 106. This may facilitate a user of the apparatus 102 to identify the obstruction dynamically. Thereafter, the user may take necessary action to unclog the dispensing aperture 106 for example, manual cleaning or change of the nozzle. This may improve the fluid flow and enhance the overall functioning of the fluid dispensing apparatus 102.

At 322, an alert may be generated. In an embodiment, the apparatus 102 may be configured to generate the alert indicative of the obstruction in the dispensing aperture 106 based on the obstruction data 204C. The alert may correspond to one of a visual alert, an auditory alert, or a digital alert.

In an embodiment, the visual alert may be one of an LED indicator that may change its color indicative of a warning, a warning light such as a high-intensity flashing light, or a gauge that may indicate a warning when its pointer reaches a warning zone (such as crossing a pre-determined pressure range of the gauge). The auditory alert may be one of a buzzer that may emit a continuous or discrete buzzing sound indicative of the warning (such as obstruction of the dispensing aperture 106 may trigger the discrete buzzing sound), an alarm, a voice alert such as a pre-recorded voice that may be rendered when the dispensing aperture 408 may be obstruction and the like. The digital alert may be one of a digital notification (such as an email, text message, and the like), a push notification such as a notification sent via a mobile application, a report such as an automated report that may include a summary of alert data, and the like.

In an exemplary embodiment, the apparatus 102 may be configured to render the alert on a display interface 324. The display interface 324 may be used to display the obstruction data 204C. In an embodiment, the apparatus 102 may be configured to display a halt message 326 on the display interface 324. For example, the apparatus 102 may be configured to display a warning alert 328. This may facilitate the user to take informed action thereby maintaining the performance of the fluid dispensing apparatus 104. For example, the user may halt or terminate the running operations when the halt message 326 is displayed on the display interface 324 and unclog the dispensing aperture 106. This may facilitate dynamically identifying the obstruction efficiently during the operation, thereby improving the fluid flow, and enhancing the overall functioning of the fluid dispensing apparatus 102.

FIG. 4 illustrates an exemplary diagram 400 of the fluid dispensing apparatus 102, in accordance with an embodiment of the present disclosure. FIG. 4 is explained in conjunction with FIG. 1, FIG. 2, FIG. 3A and FIG. 3B.

In an embodiment, the fluid dispensing apparatus 102 may include a storage unit 402, a pressure delivery unit 404, a hydraulic pressure sensor 406, and a dispensing aperture 408. The storage unit 402 may be a reservoir used to store the fluid. The fluid may be supplied to the dispensing aperture 408 through the pressure delivery unit 404, for example, a pressure pump.

In an embodiment, the fluid dispensing apparatus 102 may be one of the peristaltic pump apparatus, the diaphragm pump apparatus, the gear pump apparatus, the centrifugal pump apparatus, the piston pump apparatus, the solenoid driven dispenser apparatus, the rotary vane pump apparatus, the syringe pump apparatus, the gravity feed dispenser apparatus, or the electromagnetic pump apparatus.

The peristaltic pump apparatus may use rotating rollers that may be used to squeeze a flexible tube to push the fluid through the flexible tube. The rotating rollers may compress the flexible tube intermittently which may generate a pressure pulse in the fluid. The pressure pulse may be controlled by changing the speed of the rotating rollers. The diaphragm pump apparatus may use a diaphragm that may move back and forth to generate a vacuum. The diaphragm may be actuated by a motor or a manual mechanism which may alternatively expand and contract a pumping chamber. Further, when the diaphragm moves down, pressure may be created to push the fluid out of the pressure delivery unit 404. The generated vacuum may pump the fluid to the dispensing aperture 408.

The gear pump apparatus may use rotating gears to move the fluid through the pressure delivery unit 404. A suction may be created by the rotation of the rotating gears that may draw the fluid into the pressure delivery unit 404. The gear pump apparatus may provide a consistent flow of the fluid in a high-pressure environment. The centrifugal pump apparatus may use a rotating impeller to increase the velocity of the fluid. The fluid may be directed towards the center of the rotating impeller. The rotating impeller may be driven by a motor to spin rapidly, causing the fluid to accelerate outward due to the centrifugal force. As the fluid moves outward, the fluid velocity is increased. The increased velocity is further converted to pressure to push the fluid through the pressure delivery unit 404. The pressure of the fluid may be controlled by adjusting the speed of the rotating impeller.

The piston pump apparatus may use a piston that may move back and forth within a cylinder to dispense the fluid. The back-and-forth movement of the piston within the cylinder may create a high-pressure zone that may force the fluid to dispense out from the dispensing aperture 408. The high-pressure zone may be regulated by controlling the speed and stroke length of the piston. The piston pump apparatus may be used in fluid dispensing apparatus that may require high accuracy in a high-pressure environment. The solenoid-driven dispenser apparatus may use electromagnetic solenoids to control the dispersion of the fluid. The electromagnetic solenoids may create a mechanical force that may actuate a dispensing mechanism to control the release of the fluid. The electromagnetic solenoids may be energized by an electric current that may create a magnetic field to move a valve. The movement of the valve may open or close an orifice to allow flow of the fluid. The volume and flow rate of the fluid may be controlled by adjusting the activation time of the electromagnetic solenoids and the design of the valve. The solenoid-driven dispenser apparatus may be used for precise and controlled dispersion of the fluid.

The rotary vane pump apparatus may use a rotating vane mechanism that may create a vacuum to push the fluid through the pump. The rotating vane mechanism may use a rotor with sliding vanes to create the vacuum and build up the pressure by trapping and compressing the fluid within pump chambers. The sliding vanes may slide in and out to create varying volumes in the pump chambers. The fluid is compressed as the sliding vanes slide in and out. The compressed fluid is dispersed through a discharge port. The flow rate and the pressure may be controlled by pump speed and design of the vanes.

For example, the fluid may be pushed through the pressure delivery unit 404 of the fluid dispensing apparatus 102. The syringe pump apparatus may use a motorized mechanism to push or pull a syringe plunger which may create pressure within a syringe to dispense the fluid. The syringe may be filled with the fluid. The syringe plunger may be moved by a motor to build up the pressure and push the fluid through a needle (such as the dispensing aperture 408). The pressure may be regulated by adjusting the speed and force of the syringe plunger movement.

The gravity feed dispenser apparatus may use gravity to dispense the fluid. The pressure in the gravity feed dispenser apparatus may be generated by the height of a fluid column above the dispensing point. A fluid reservoir may be positioned at a height. The fluid may use gravity for the fluid to flow downward. The pressure at the dispensing point may be proportional to the height of the height column. The pressure may be regulated by changing the height of the fluid reservoir (such as the storage unit 402). The gravity feed dispenser apparatus may provide a controlled flow rate of the fluid. The electromagnetic pump apparatus may use electromagnetic fields to move the fluid without physical contact. An interaction between electric currents and magnetic fields may be used to generate Lorentz force. The generated Lorentz force may move the fluid with a pressure. The fluid may be a conductive fluid. The Lorentz force may refer to a force exerted on a charged particle moving through a magnetic field.

In an embodiment, the fluid may include at least a portion of an aerosolized sealant. The aerosolized sealant may include at least one of an aerosol foam sealant, an aerosol silicone sealant, an aerosol rubberized sealant, an aerosol undercoating, or an aerosol leak sealant.

The aerosol foam sealant may be used to seal areas that require insulation such as gaps and cracks around windows, doors, and the like. The aerosol foam sealant may be sprayed in the gaps and cracks around the windows, doors, and the like. The sprayed aerosol foam sealant may expand to seal the gaps and cracks around the windows, doors, and the like. The aerosol silicone sealant may be used to seal joints and seams of places where flexibility and resistance to weathering are required such as glass surfaces, metal surfaces, ceramic, and the like.

The aerosol rubberized sealant may be used to provide a waterproof seal to surfaces where weather-resistant coating is required. The aerosol rubberized sealant may be used to seal leaks in a roof, air vents, and the like. The aerosol undercoating may be used to protect the underside of a vehicle from rust and corrosion. The aerosol undercoating may be a bituminous material (such as asphalt, bitumen, tar, and the like) or a rubberized material that may be sprayed on the underside of the vehicle to provide a layer to prevent the vehicle from rust and corrosion. The aerosol leak sealant may be used to seal small leaks in apparatus such as automotive cooling apparatus, air conditioning apparatus, and the like. The aerosol leak sealant may form a seal after being sprayed in the leak.

In an embodiment, the fluid dispensing apparatus 102 may include one or more sensors. Each of the one or more sensors may be the hydraulic pressure sensor 406. The hydraulic pressure sensor 406 may be used to measure the pressure within a hydraulic apparatus of the fluid dispensing apparatus 410. In an embodiment, the hydraulic pressure sensor 406 may be used to measure the pressure of the fluid dispensing from the dispensing aperture 408. The hydraulic pressure sensor 406 may include a pressure sensing element, a transducer, and an output signal. The pressure sensing element may be a piezoelectric element (such as quartz crystal, barium titanate, aluminum nitride, and the like) that may produce a change in an electrical signal based on a change in the pressure of the fluid. The pressure-sensing element may be connected to the transducer. The transducer may be used to convert physical pressure measurement into an electrical signal. The electrical signal may be used to monitor the fluid dispensing apparatus 102. The output signal may be the electrical signal generated by the transducer. In an embodiment, the output signal may be the alert signal. In an embodiment, the hydraulic pressure sensor 406 may be calibrated to measure a specific range of pressure. For example, the hydraulic pressure sensor 406 may be calibrated to measure a pressure range from, but not limited to, 0 psi to 3500 PSI for the fluid dispensing apparatus 402.

In an embodiment, the hydraulic pressure sensor 406 may be one of a strain gauge sensor, a piezoelectric sensor, a capacitive sensor, an optical sensor, or a bourbon tube sensor. The strain gauge sensor may use a strain gauge that may deform under pressure. The deformation changes the electrical resistance of the strain gauge which is further converted into an electrical signal.

The piezoelectric sensor may use piezoelectric materials (such as quartz crystal, barium titanate, aluminum nitride, and the like) that may generate an electrical charge in response to mechanical stress. The electrical charge may be proportional to an applied pressure on the piezoelectric sensor. The capacitive sensor may be used to measure the pressure by detecting a change in capacitance between two conductive plates of the capacitive sensor. The pressure may change the distance between the two conductive plates which may alter the capacitance of the capacitive sensor.

The optical sensor may use light-based methods (such as the use of photodiodes, light-emitting diodes (LEDs), and the like) to measure pressure changes. The bourbon tube sensor may use a curved and hollow tube that may straighten up as the pressure elevates. The movement of the curved and hollow tube may be transmitted to an electronic transducer to detect the change in pressure.

In an embodiment, the dispensing aperture 408 may be one of a needle dispensing aperture, an atomizing dispensing aperture, a spray dispensing aperture, a pinch dispensing aperture, a dropper dispensing aperture, a micropipette dispensing aperture, an air-assisted dispensing aperture, a flow control dispensing aperture, a rotary dispensing aperture, a pressure activated dispensing aperture, or a capillary dispensing aperture.

The needle dispensing aperture may use a needle mechanism to control the flow of the fluid. The needle dispensing aperture may be used to precisely dispense a small volume of the fluid. The atomizing needle may be designed to generate a fine mist or spray of the fluid. The atomizing needle may be used for wide dispersion of the fluid. The spray dispensing aperture may create a spray pattern for the fluid to cover a large area. The spray dispensing aperture may be used for spraying the fluid in a pattern such as a flat fan pattern, a cone pattern, a hollow cone pattern, and the like.

The pinch dispensing aperture may use a pinching mechanism to pinch or compress the flexible tube to control the flow of the fluid. The dropper dispensing aperture may be designed to dispense the fluid in discrete drops. The micropipette dispensing aperture may be used in micropipettes to deliver a small and very precise amount of fluid. The micropipette dispensing aperture may be used to achieve high accuracy in terms of fluid targets.

The air-assisted dispensing aperture may use compressed air to assist the dispersion of the fluid. The air-assisted dispensing aperture may be used in applications where linear sprays and better coverage of the fluid need to be achieved. The flow control dispensing aperture may be designed to regulate the flow of the fluid. The flow control dispensing aperture may be used in applications where precise control over the flow rate is required.

The rotary dispensing aperture may include a rotating mechanism that may allow even distribution of the fluid over a large area. The pressure-activated dispensing aperture may be used in applications where the pressure may vary. The pressure-activated dispensing aperture may vary the dispensing aperture opening to maintain consistent dispensing of the fluid. The capillary dispensing aperture may use the principle of capillary action to dispense small quantities of the fluid. The principle of capillary action may refer to the ability of a liquid to flow in narrow spaces without the assistance of any external forces (such as gravity).

FIG. 5A, FIG. 5B, and FIG. 5C illustrate exemplary diagrams of the dispensing aperture 408 associated with the fluid dispensing apparatus 102, in accordance with an embodiment of the disclosure. FIG. 5A, FIG. 5B, and FIG. 5C are explained in conjunction with FIG. 1, FIG. 2, FIG. 3A, FIG. 3B, and FIG. 4.

Referring to FIG. 5A, there is shown an exemplary diagram 500A of the dispensing aperture 408 associated with the fluid dispensing apparatus 102. In an embodiment, at a time ‘T1’, the dispensing aperture 408 may not be clogged, as shown at 502. This may facilitate a consistent flow of the fluid through the dispensing aperture 408.

Referring to FIG. 5B, there is shown an exemplary diagram 500B of the dispensing aperture 408 associated with the fluid dispensing apparatus 102. In an embodiment, at a time ‘T2’, the dispensing aperture 408 may be clogged, as shown at 504, there may be buildup due to fluid residue over the time period. This may lead to obstruction in the dispensing aperture 408. The fluid residue may have adhesive properties such that the particles may get stuck at an inside layer of the dispensing aperture 408, as shown at 504. The adhesive properties of the fluid residue may reduce the size of an opening of the dispensing aperture 408 leading to obstruction of the dispensing aperture 408.

Referring to FIG. 5C, there is shown an exemplary diagram 500C of the dispensing aperture 408 associated with the fluid dispensing apparatus 102. In an embodiment, at a time ‘T3’, the dispensing aperture 408 may be obstructed or clogged due to the presence of a particle 506 at the opening of the dispensing aperture 408. In an embodiment, the apparatus 102 may be configured to render the alert signal indicative of obstruction of the dispensing aperture 408. At the time ‘T4’, the dispensing aperture 408 may be obstructed due to the presence of the particle 506 on the opening of the dispensing aperture 408. The size of the particle 506 may be greater than the diameter of the dispensing aperture 408. The particle 506 may get stuck on the dispensing aperture 408 which may not allow dispersion of the fluid through the dispensing aperture 408 leading to obstruction of the dispensing aperture 408.

FIG. 6A, FIG. 6B, FIG. 6C and FIG. 6D illustrate exemplary diagrams of the dispensing aperture 408 associated with the fluid dispensing apparatus 102, in accordance with an embodiment of the disclosure. FIG. 6A, FIG. 6B, FIG. 6C and FIG. 6D are explained in conjunction with FIG. 1, FIG. 2, FIG. 3A, FIG. 3B, FIG. 4, FIG. 5A, FIG. 5B and FIG. 5C.

Referring to FIG. 6A, there is shown an exemplary side-view 600A of the dispensing aperture 408 associated with the fluid dispensing apparatus 102. The dispensing aperture 408 may correspond to a nozzle designed to control the direction, flow, and speed of the fluid to be dispensed. The dispensing aperture 408 includes a housing 602 providing structure and support to one or more components, for example, but not limited to, a seal, a seal ring 604, and a nozzle tip 606. The housing 602 may be made of materials, such as but not limited to metals (such as brass or stainless steel) or high-strength plastics. The material of the housing 602 may be resistant to pressure or corrosion due to the fluid. Further, the dispensing aperture 408 includes mounting threads 608 designed to securely attach the dispensing aperture 408 to the fluid dispensing apparatus 102. In an example, the mounting threads 608 may be made of metal, high-strength plastic material, or any other material similar to the material of the housing 602.

Further, the seal may be positioned between the nozzle and the one or more components to prevent leakage of the fluid from the fluid dispensing apparatus 102. The seal is made of material such as but not limited to rubber, silicone, or other materials to withstand the pressure and the temperature of the fluid. Additionally, the seal ring 604 may be positioned between the housing 602 and the mounting threads 608 to enhance sealing. This may ensure a tight connection between the fluid dispensing apparatus 102 and the dispensing aperture 408. The seal ring 604 may be made of a material such as but not limited to metal or high-temperature resistant materials, such as Teflon. The nozzle tip 606 refers to an opening of the dispensing aperture from where the fluid is dispensed through the dispensing aperture 408. The nozzle tip 606 may be made of a material, such as but not limited to stainless steel, brass, ceramic, or other materials that resist wear and corrosion.

Referring to FIG. 6B, there is shown an exemplary cross-sectional view 600B of the dispensing aperture 408 associated with the fluid dispensing apparatus 102. There is shown an interior space within the housing 602 that facilitates the consistent flow of the fluid through the dispensing aperture 408.

Referring to FIG. 6C there is shown another exemplary cross-sectional view 600C of the dispensing aperture 408 associated with the fluid dispensing apparatus 102. Further, the nozzle tip 606 may include a threading connector (such as mounting threads) for easy installation or removal, thereby making maintenance of the nozzle tip 606 convenient.

Referring to FIG. 6D, there is shown an exemplary top view 600D of the nozzle tip 606. There is shown an opening 606A of the nozzle tip 606 that may allow dispersion of the fluid through the dispensing aperture 408. It is shown that the dispensing aperture 408 includes the housing 602, the seal ring 604, and the nozzle tip 606, however, the disclosure may not be so limiting and the dispensing aperture 408 may include fewer or additional components to perform the same or other functions of the dispensing aperture 408.

FIG. 7 illustrates an exemplary flowchart 700 of a method for obstruction detection in the fluid dispensing apparatus 102, in accordance with an embodiment of the disclosure. FIG. 7 is explained in conjunction with elements from FIG. 1, FIG. 2, FIG. 3A, FIG. 3B, FIG. 4, FIG. 5A, FIG. 5B, FIG. 5C, FIG. 6A, FIG. 6B, FIG. 6C and FIG. 6D. The operations of the exemplary method may be executed by any computing apparatus, for example, by the apparatus 102 of FIG. 1 or the processor 202 of FIG. 2. The operations of the flowchart 700 may start at 702.

At 702, the first pressure value 204A associated with the dispensing aperture 106 may be received. In an embodiment, the apparatus 102 may be configured to receive the first pressure value 204A associated with the dispensing aperture 106 at the first time period. The dispensing aperture 106 is operable to dispense the fluid stored in the storage unit 108 of the apparatus 102. The first pressure value 204A is indicative of a first volume of the fluid dispensed through the dispensing aperture 106. Details about receiving the first pressure value 204A are provided, for example, in FIG. 3A and FIG. 3B.

At 704, the second pressure value 204B associated with the dispensing aperture 106 may be received. In an embodiment, the apparatus 102 may be configured to receive the second pressure value 204B associated with the dispensing aperture 106 at the second time period. The second pressure value is indicative of a second volume of the fluid dispensed through the dispensing aperture 106. Further, the second time period is subsequent to the first time period. Details about receiving the second pressure value 204B are provided, for example, in FIG. 3A and FIG. 3B.

At 706, the change value associated with the flow of the fluid through the dispensing aperture 106 may be determined. In an embodiment, the apparatus 102 may be configured to determine the change value associated with the flow of the fluid through the dispensing aperture 106 based on the first pressure value 204A and the second pressure value 204B. Details about the determination of the change value is provided, for example, in FIG. 3A and FIG. 3B.

At 708, the operational state of the pressure delivery unit 108 may be determined. In an embodiment, the apparatus 102 may be configured to determine the operational state of the pressure delivery unit 108 based on the change value. The operational state corresponds to one of a first state, or a second state. The first state corresponds to an active state of the pressure delivery unit 108 and the second state corresponds to an inactive state of the pressure delivery unit 108. Details about the determination of the operational state of the pressure delivery unit 108 are provided, for example, in FIG. 3A and FIG. 3B.

At 710, the obstruction in the dispensing aperture 106 may be identified. In an embodiment, the apparatus 102 may be configured to identify the obstruction in the dispensing aperture 106 based on the change value to correspond to a predefined threshold. The predefined threshold is based on the operational state of the pressure delivery unit 108. Details about the obstruction identification are provided, for example, in FIG. 3A and FIG. 3B.

At 712, the obstruction data 204C may be generated. In an embodiment, the apparatus 102 may be configured to generate the obstruction data 204C based on the identified obstruction and device data associated with the fluid dispensing apparatus 102. Details about the generation of the obstruction data are provided, for example, in FIG. 3A and FIG. 3B.

At 714, the obstruction data may be outputted. In an embodiment, the apparatus 102 may be configured to output the obstruction data 204C.

Accordingly, blocks of the flowchart 700 support combinations of means for performing the specified functions and combinations of operations for performing the specified functions. It will also be understood that one or more blocks of the flowchart 700, and combinations of blocks in the flowchart 700, can be implemented by special-purpose hardware-based computer apparatus that perform the specified functions, or combinations of special-purpose hardware and computer instructions.

Alternatively, the apparatus 102 may comprise means for performing each of the operations described above. In this regard, according to an example embodiment, examples of means for performing operations may comprise, for example, the processor and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A fluid dispensing apparatus, the apparatus comprising:
a storage unit to store a fluid;
a dispensing aperture to dispense the fluid;
a pressure delivery unit to supply pressure to cause a flow of the fluid from the storage unit to the dispensing aperture; and
one or more processors configured to execute computer-executable instructions to:
receive a first pressure value associated with the dispensing aperture at a first time period, wherein the first pressure value is indicative of a first volume of the fluid dispensed through the dispensing aperture;
receive a second pressure value associated with the dispensing aperture at a second time period, wherein the second pressure value is indicative of a second volume of the fluid dispensed through the dispensing aperture, and wherein the second time period is subsequent to the first time period;
determine a change value associated with the flow of the fluid through the dispensing aperture based on the first pressure value and the second pressure value;
determine an operational state of the pressure delivery unit based on the change value, wherein the operational state corresponds to one of: a first state, or a second state;
identify an obstruction in the dispensing aperture based on the change value to correspond to a predefined threshold, wherein the predefined threshold is based on the operational state of the pressure delivery unit;
generate obstruction data based on the identified obstruction and device data associated with the fluid dispensing apparatus; and
output the obstruction data.

2. The fluid dispensing apparatus of claim 1, wherein the first state corresponds to an active state of the pressure delivery unit, and wherein the one or more processors are further configured to:
determine the change value greater than the predefined threshold associated with the active state of the pressure delivery unit; and
identify the obstruction in the dispensing aperture based on the determination.

3. The fluid dispensing apparatus of claim 1, wherein the second state corresponds to an inactive state of the pressure delivery unit, and wherein the one or more processors are further configured to:
determine change value less than the predefined threshold associated with the inactive state of the pressure delivery unit; and
identify the obstruction in the dispensing aperture based on the determination.

4. The fluid dispensing apparatus of claim 1, wherein the one or more processors are further configured to generate a notification associated with the obstruction in the dispensing aperture based on the obstruction data.

5. The fluid dispensing apparatus of claim 1, wherein the one or more processors are further configured to:
generate an alert indicative of the obstruction in the dispensing aperture based on the obstruction data; and
output the alert.

6. The fluid dispensing apparatus of claim 5, wherein the alert corresponds to one of: a visual alert, an auditory alert, or a digital alert.

7. The fluid dispensing apparatus of claim 1, wherein the fluid dispensing apparatus further comprising one or more sensors, and wherein the one or more processors are further configured to receive, using the one or more sensors, the first pressure value associated with the dispensing aperture and the second pressure value associated with the dispensing aperture.

8. The fluid dispensing apparatus of claim 7, wherein the one or more sensors comprises a hydraulic pressure sensor.

9. The fluid dispensing apparatus of claim 1, wherein the fluid comprises at least a portion of an aerosolized sealant.

10. A method, comprising:
receiving a first pressure value associated with a dispensing aperture at a first time period, wherein the first pressure value is indicative of a first volume of a fluid dispensed through the dispensing aperture;
receiving a second pressure value associated with the dispensing aperture at a second time period, wherein the second pressure value is indicative of a second volume of the fluid dispensed through the dispensing aperture, and wherein the second time period is subsequent to the first time period;
determining a change value associated with a flow of the fluid through the dispensing aperture based on the first pressure value and the second pressure value;
determining an operational state of a pressure delivery unit based on the change value, wherein the operational state corresponds to one of: a first state, or a second state;
identifying an obstruction in the dispensing aperture based on the change value to correspond to a predefined threshold, wherein the predefined threshold is based on the operational state of the pressure delivery unit;
generating obstruction data based on the identified obstruction and device data associated with the fluid dispensing apparatus; and
outputting the obstruction data.

11. The method of claim 10, wherein the first state corresponds to an active state of the pressure delivery unit, and wherein the method further comprising:
determining the change value greater than the predefined threshold associated with the active state of the pressure delivery unit; and
identifying the obstruction in the dispensing aperture based on the determination.

12. The method of claim 10, wherein the second state corresponds to an inactive state of the pressure delivery unit, and wherein the method further comprising:
determining change value less than the predefined threshold associated with the inactive state of the pressure delivery unit; and
identifying the obstruction in the dispensing aperture based on the determination.

13. The method of claim 10, wherein the method further comprises generating a notification associated with the obstruction in the dispensing aperture based on the obstruction data.

14. The method of claim 10, further comprising:
generating an alert indicative of the obstruction in the dispensing aperture based on the obstruction data; and
outputting the alert.

15. The method of claim 14, wherein the alert corresponds to one of: a visual alert, an auditory alert, or a digital alert.

16. The method of claim 10, further comprising receiving, using one or more sensors, the first pressure value associated with the dispensing aperture and the second pressure value associated with the dispensing aperture.

17. The method of claim 16, wherein the one or more sensors comprises a hydraulic pressure sensor.

18. The method of claim 10, wherein the fluid comprises at least a portion of an aerosolized sealant.

19. A computer programmable product comprising a non-transitory computer readable medium having stored thereon computer executable instructions for controlling an operation of a testing device for performing an air leakage test, which when executed by one or more processors, cause the one or more processors to carry out operations comprising:
receiving a first pressure value associated with a dispensing aperture at a first time period, wherein the first pressure value is indicative of a first volume of a fluid dispensed through the dispensing aperture;
receiving a second pressure value associated with the dispensing aperture at a second time period, wherein the second pressure value is indicative of a second volume of the fluid dispensed through the dispensing aperture, and wherein the second time period is subsequent to the first time period;
determining a change value associated with a flow of the fluid through the dispensing aperture based on the first pressure value and the second pressure value;
determining an operational state of a pressure delivery unit based on the change value, wherein the operational state corresponds to one of: a first state, or a second state;
identifying an obstruction in the dispensing aperture based on the change value to correspond to a predefined threshold, wherein the predefined threshold is based on the operational state of the pressure delivery unit;
generating obstruction data based on the identified obstruction and device data associated with the fluid dispensing apparatus; and
outputting the obstruction data.

20. The computer programmable product of claim 19, further comprising generating a notification associated with the obstruction in the dispensing aperture based on the obstruction data.
